(19) United States
(12) Patent Application Publication
(10) Pub. No.: US 2021/0168423 A1
(43) Pub. Date: Jun. 3, 2021

(54) Systems and Methods for Delivery of a Service

(71) Applicant: TRANS PACIFIC VENTURES LIMITED, Hamilton (NZ)

(72) Inventors: Neil SINGH, Hamilton (NZ); Paul John CAVANAGH, Hamilton (NZ)

(73) Assignee: Trans Pacific Ventures Limited, Hamilton (NZ)

(21) Appl. No.: 17/044,935

(22) PCT Filed: Apr. 3, 2019
(86) PCT No.: PCT/NZ2019/050034

§ 371 Date: Oct. 2, 2020

(30) Foreign Application Priority Data
Apr. 3, 2018 (NZ) 741270

(51) Int. Cl. H04N 21/2543; G06Q 30/02; G06Q 30/06

(52) U.S. Cl. CPC H04N 21/25435; G06Q 30/0641; G06Q 30/0277; G06Q 30/0236

(57) ABSTRACT

Systems and methods for delivery of a service to a consumer wherein a service package is presented to a consumer via a user device. The service package has an associated service and a consumption value for delivery of the service. Presenting the service package includes presenting a plurality of selectable advertising conditions to the consumer, each condition having an associated subsidy value. One or more of the advertising conditions having a combined subsidy value equivalent to, or greater than, the consumption value are selected, and the service associated with the service package is delivered on the completion of the selected advertising conditions.

### STATEMENT OF CORRESPONDING APPLICATIONS

This application is based on the specification filed in relation to New Zealand Patent Application No. 741270, the entire contents of which are incorporated herein by reference.

### TECHNICAL FIELD

Embodiments of the present disclosure relate to systems and methods for delivery of a service—more particularly delivery of advertiser subsidised digital multimedia content.

### BACKGROUND

Numerous platforms are available for the consumption of multimedia content, but typically take two approaches to compensation for access to that content.

The first option is to have advertising interspersed between the content being consumed, at a rate specified by the owners of the platform from which the content is delivered. The advertising is generally geared as much as possible to the type of consumer that is assumed to be receiving particular media content. This type of content is commonly free-to-air, with the advertising compensating for the price of delivering the content.

Such advertising is interruptive and forced upon customers using increasingly intrusive methods, for example advertising popups and interruptive ad video inlays. This creates consumer frustration, and a lack of interest to engage in a meaningful way with the advertiser, reducing the value of such advertising to the customer and advertiser. This has seen the growth in the use of ad skipping and blocking technologies—at times encouraged by content providers in order to lower consumer disengagement or abandonment of content. While counter intuitive to the business model of content providers and advertisers that support them, some consider it necessary to stay competitive under current ad-content delivery models.

The interruption of content by advertisements results in increasing the amount of time required to consume the content, and much of the advertising being shown is not relevant, or of little interest, to the consumer. Hence, advertisers have a limited number of consumers that are active participants in any consumption of the advertising, and subsequently the advertiser receives limited returns on their advertising investment. Low levels of “emotional purchasing” due to advertising overload, interruptive disengagement and/or complacency around advertising as a requirement for the consumer to get to the content.

The other option is paid content which is free of advertising, or at least heavily reduced. Many consumers feel unable to access content at an affordable price point, which has contributed to the growth of piracy of content. This advertisement free option is of no benefit to the advertisers as they are missing opportunities to promote their goods and services to potential customers. For content creators, there is a risk of consumers being unwilling to expand their content consumption through additional expenditure of disposable income—particularly casual or fringe buyers of content.

Further, these models have resulted in little to no opportunity for low to mid-level content (such as local sporting events, or created by less established musical artists or other producers of artistic content) to promote and monetize their particular genre effectively, outside of cluttered low return markets such as YouTube or Dailymotion etc.

It is an object of the present invention to address at least one of the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Further aspects and advantages of the present invention will become apparent from the ensuing description which is given by way of example only.

### SUMMARY

According to an aspect of the present disclosure there is provided a method including the steps of:
presenting at least one service package to a consumer via a user device, wherein each service package has an associated service, a consumption cost, and an advertisement level associated with the consumption cost;
receiving a selection of the service package by the consumer;
delivering the service associated with the service package, in accordance with the associated advertisement level.

According to an aspect of the present disclosure there is provided a method including the steps of:
presenting a service package to a consumer via a user device, wherein each service package has an associated service, and a consumption value for delivery of that service, wherein presenting the service package includes presenting a plurality of selectable advertising conditions to the consumer, each condition having an associated subsidy value;
receiving selection of one or more of the advertising conditions having a combined subsidy value equivalent to, or greater than, the consumption value; and
delivering the service associated with the service package on completion of the selected advertising conditions.

According to an aspect of the present disclosure there is provided a method including the steps of:
delivering a service to a consumer via a user device;
presenting an advertising offer to the consumer during delivery of the service, and
receiving an indication of acceptance of the offer by the consumer, and recording acceptance of the offer against records associated with the consumer.

According to another aspect of the present disclosure there is provided computer executable instructions for performing one or more of the methods as described herein.

According to another aspect of the present disclosure there is provided a system configured to operate in accordance with one or more of the methods as described herein.

According to one aspect of the present disclosure there is provided a system for delivery of a service to a consumer, the system comprising at least one processing means configured to:
deliver a service package to a user device for presentation to the consumer, wherein each service package has an associated service, and a consumption value for delivery of the service, wherein presenting the service package includes presenting a plurality of selectable advertising conditions to the consumer in a user interface displayed on the user device, each condition having an associated subsidy value;
receive selection of one or more of the advertising conditions having a combined subsidy value equivalent to, or greater than, the consumption value; and
deliver the service associated with the service package to the user device on completion of the selected advertising conditions.

According to another aspect of the present disclosure there is provided a consumer device configured to interact with the system in accordance with one or more of the methods as described herein.

According to another aspect of the present invention there is provided at least one user interface to interact with the system in accordance with one or more of the methods as described herein.

The present disclosure can relate to a variety of services, but it is envisaged that exemplary embodiments may have particular application to services provided on digital computer-based systems. More particularly, it is envisaged that the service may relate to the provision of multimedia content combining different content forms such as text, audio, images, animations, video and interactive content (for example, games)—although it should be appreciated that this is not intended to be limiting to all embodiments. In exemplary embodiments, the service may relate to transmission of video content—whether pre-recorded, or from a live event.

The “user device” may include any suitable device capable of display of content and the requisite user input, for example: mobile devices, cell phones, gaming consoles, personal computers (whether desktop, laptop, or tablets), televisions, and the like. It should be appreciated that individual steps of the methods disclosed herein involving input from (or output to) a user device may be performed across multiple devices. For example, a service package may be presented to a consumer on one device (such as a mobile phone), and the service subsequently delivered to a second device (such as a television).

Reference to a “consumption value” should be understood to mean the value ascribed to a service by the service provider. Reference to the “consumption cost” of a service should be understood to mean a cost to be paid by the consumer in order to meet the consumption value. By way of example, in the case of a traditional broadcast of live events, the consumption cost may equivalent to a pay-per-view cost.

In an exemplary embodiment, the consumption value or cost may be determined on the basis of the service relating to a discrete event (for example, a transmission of a singular live event, or content such as a movie), similar to a pay per view arrangement. In an exemplary embodiment, the consumption value or cost may be determined on the basis of ongoing access to a service (for example, a season pass to a plurality of live events, or a library of content to be accessed on-demand), in a subscription-type arrangement.

Reference to an advertising level of a service package should be understood to mean a variable characteristic of advertising to be delivered to the consumer in the course of delivering the service.

By way of example, the advertising level may relate to one or more of: timing of delivery of the advertising (for example, one or more of: prior, during, or subsequent to delivery of the service), a quantity of the advertising (for example, one or more of: length of the advertising, or number of advertising instances), the frequency at which advertising is delivered during provision of the service, location or prominence of the advertising, and type of advertising.

Reference to an advertising condition should be understood to mean an action to be satisfied in order to meet predetermined requirements for the consumer to receive the benefit of an associated subsidy value. For example, an advertising condition may be the viewing of one or more advertisements from a particular advertiser. In exemplary embodiments, satisfying the advertising condition may require manual confirmation from a consumer that an advertisement has been viewed or otherwise engaged with. In an exemplary embodiment, the advertising conditions may be displayed to the consumer in a user interface provided on the user device—for example, within selectable tiles.

It is envisaged that the advertising level or meeting of advertising conditions, will at least partially contribute to meeting the consumption value. In an exemplary embodiment, the consumer may be presented with a plurality of selectable advertising conditions, each condition having an associated subsidy value. Selection of an advertising condition will set the associated value against the consumption value, to determine the consumption cost.

In exemplary embodiments, the consumer may be required to select an advertising level which fully meets the consumption value—i.e. the consumption cost to the consumer is nil in terms of cash outlay.

In exemplary embodiments, the consumer may select an advertising level which does not meet the consumption value, and pay the residual consumption cost. In doing so, the consumer is provided with an opportunity to at least partially determine the value of the service that they wish to pay for. An alternative way to view this is that the consumer is choosing how much of the service is going to be subsidised by the accompanying advertisement level—i.e. the consumption value is adjusted through the partial payment. It is envisaged that in exemplary embodiments the consumer may be given the option to pay a consumption cost equal to the consumption value. It should be appreciated that payment of the consumption cost may be provided by any suitable means in the art, for example customer account, credit card, Internet banking, online payment systems, and so on.

In some embodiments, the customer may in turn choose the advertisement level wanted in respect of a particular service package which will then determine consumption cost. There may be a sliding scale for the consumption cost, which in combination with a sliding scale of advertisement level, can provide a multitude of effective service packages. In an exemplary embodiment, the consumer may choose a ratio of paid to subsidized value they wish to receive (for example, 80:20, 60:40; 50:40, 40:60, 20:80).

In an exemplary embodiment of the present disclosure, the level of advertising (or advertising conditions) may be determined based on the selected ratio and the consumption value. This may be achieved using an algorithm, or based on discrete service packages (for example, having an associated entry in a look-up table).

It should be appreciated that the relationship between the advertising level and the consumption cost is not necessarily inversely proportional. However, it is envisaged that a lower consumption cost may result in a higher advertising level, while a higher consumption cost may result in fewer advertisements. It is envisaged that in exemplary embodiments, the advertising content may be influenced by the elected consumption cost—with consumers electing higher consumption costs being delivered advertising directed to higher value products in comparison with those wishing to have a lower consumption cost.

In an exemplary embodiment, a service delivery interface is provided, through which a consumer accesses a service. In an exemplary embodiment the interface may include a service portion, in which the service is displayed, and an active advertising area through which advertising offers are presented during delivery of the service. By way of example, the service portion may be a video player, a game interface, or a web application interface.

It should be appreciated that while it is envisaged that the active advertising area may be used in conjunction with exemplary embodiments in which consumers select a service package and/or advertising conditions, this is not intended to be limiting to all embodiments. It is expressly contemplated that the active advertising area and associated functionality described herein may be utilised in conjunction with other service delivery systems. By way of non-limiting example, the active advertising area may be provided with known streaming or broadcast services.

In an exemplary embodiment, the advertising offer may be presented as an icon within the active advertising area. In an exemplary embodiment, selection of the advertising offer icon may display an expanded advertising interface for interaction with the consumer—for example providing details of the offer, and buttons or fields for acceptance or rejection of the offer.

In an exemplary embodiment, the expanded advertising interface may be displayed over at least a portion of the service portion—for example, in an overlay. However, it should be appreciated that this is not intended to be limited to all embodiments—for example, the expanded advertising interface may be displayed within the active advertising area, or the size of the service portion reduced to accommodate the expanded advertising interface without impinging on the view of the service portion.

In an exemplary embodiment, an advertising offer may be designated as being selectable by the consumer for a limited period of time—i.e. the offer expires after a pre-determined period of time. In an exemplary embodiment, one or more of the advertising offer icon, and the expanded advertising interface, may include an indication of the remaining time available to select the offer.

In an exemplary embodiment, presentation of an advertising offer may be initiated by an operator. It is envisaged that this may provide advertisers with an opportunity to actively gauge the likely state of engagement of a consumer based on current conditions within the delivery of the service, and allow for decision making around timing and focus of the advertising offer accordingly. It is envisaged that this may assist with delivery of the offers at times more likely to have a higher value perception, and strengthen the brand bond between the consumer and advertiser. For example, during a sporting event, an advertising offer may be presented to consumers having a geolocation more likely to be affiliated with one of the teams, following a positive event for that team.

In an exemplary embodiment, the advertising offer may be delivered to a subset of the total consumer base for a particular service—for example, based on pre-entered characteristics of the consumer such as demographic information, location, affiliations, or other preferences.

In an exemplary embodiment, timing of presentation of an advertising offer may be pre-determined. In an exemplary embodiment, presentation of an advertising offer may be initiated on an event occurrence. For example, for a sporting event, an advertising offer may be presented during a break in play—whether pre-programmed, initiated by triggers provided by the content provider, or automated event recognition by the service delivery platform operator. In exemplary embodiments in which an indication of remaining time to accept the offer is available, the period of time may be manually designated by an operator. In exemplary embodiments, the period of time may be automatically determined based on the known or projected length of the event occurrence.

In an exemplary embodiment the system may include an application programming interface (API) module configured to manage interfacing with external services. The API module may manage the respective authentication, authorisation, and encryption protocols required for the system to interface with the respective APIs of the services.

For a firmware and/or software (also known as a computer program) implementation, the techniques of the present disclosure may be implemented as instructions (for example, procedures, functions, and so on) that perform the functions described. It should be appreciated that the present disclosure is not described with reference to any particular programming language, and that a variety of programming languages could be used to implement the present invention. The firmware and/or software codes may be stored in a memory, or embodied in any other processor readable medium, and executed by a processor or processors. The memory may be implemented within the processor or external to the processor.

A general purpose processor may be a microprocessor, but in the alternative, the processor may be any processor, controller, microcontroller, or state machine. A processor may also be implemented as a combination of computing devices, for example, a combination of a digital signal processor (DSP) and a microprocessor, a plurality of microprocessors, one or more microprocessors in conjunction with a DSP core, or any other such configuration. The processors may function in conjunction with servers, whether cloud based or dedicated, and network connections as known in the art.

In various embodiments, one or more cloud computing environments may be used to create, and/or deploy, and/or operate at least part of the software system that can be any form of cloud computing environment, for example: a public cloud, a private cloud, a virtual private network (VPN), a subnet, a Virtual Private Cloud (VPC), or any other cloud-based infrastructure known in the art. It should be appreciated that a service may utilize, and interface with, multiple cloud computing environments.

The steps of a method, process, or algorithm described in connection with the present disclosure may be embodied directly in hardware, in a software module executed by one or more processors, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

### BRIEF DESCRIPTION OF DRAWINGS

Further aspects of the present invention will become apparent from the following description which is given by way of example only and with reference to the accompanying drawings in which:

FIG. 1 is a schematic diagram of an exemplary networked system for a content delivery service in accordance with an embodiment of the present disclosure;

FIG. 2 is a block diagram of an exemplary content delivery service;

FIG. 3-1 is schematic diagram of a first exemplary architecture for implementation of the exemplary content delivery service;

FIG. 3-2 is schematic diagram of a second exemplary architecture for implementation of the exemplary content delivery service;

FIG. 4 is a flow diagram of an exemplary method for delivery of content to a consumer;

FIGS. 5-1 and 5-2 are components of an exemplary consumer interface for registration of the consumer;

FIG. 6 is a flow diagram of an exemplary method for selection of content and satisfying pre-consumption conditions;

FIGS. 7-1 to 7-6 are components of an exemplary consumer interface for selection of content and satisfying pre-consumption conditions;

FIG. 8 is a flow diagram of an exemplary method for delivering content and advertising offers to the consumer;

FIGS. 9-1 to 9-6 are components of an exemplary consumer interface for viewing of content and advertising offers by the consumer;

FIG. 10 is a flow diagram of an exemplary method for initiating an advertising campaign;

FIGS. 11-1 to 11-3 are components of an exemplary advertiser interface for creation and monitoring of advertising campaigns;

FIG. 12 is a flow diagram of an exemplary method for creation and delivery of advertising offers;

FIGS. 13-1 to 13-3 are components of an exemplary advertiser interface for creation and monitoring of advertising offers for real-time advertising;

FIG. 14 is a flow diagram of an exemplary method for making payments to adjust consumption conditions

FIG. 15 is a component of an exemplary consumer interface for satisfying pre-consumption conditions.

### DETAILED DESCRIPTION

The exemplary embodiments described herein will be discussed in the context of delivery of multimedia content, and more particularly video content. However, it should be appreciated that this is not intended to be limiting to all implementations of the present disclosure, as delivery of other services is expressly contemplated, as previously discussed.

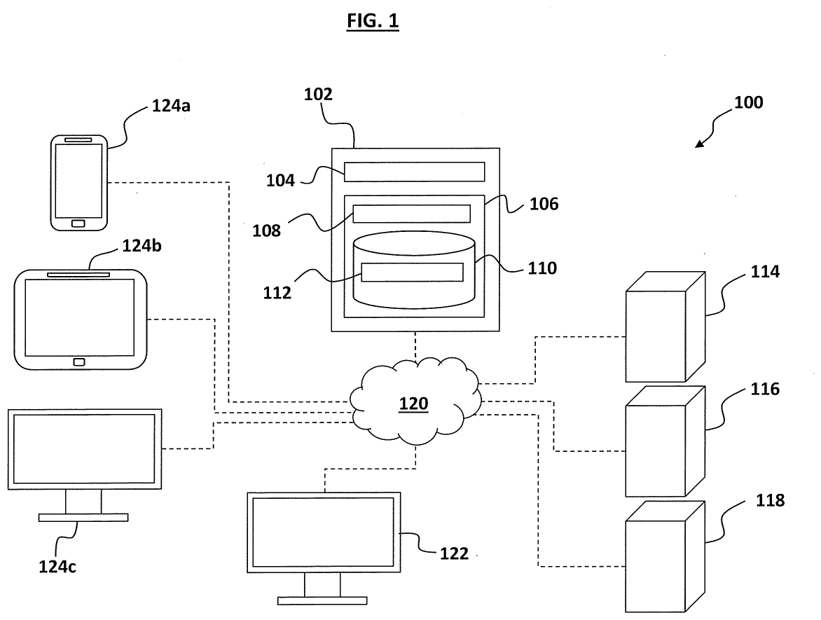

FIG. 1 presents a schematic diagram of a system 100 depicting various computing devices that can be used alone or together in accordance with exemplary embodiments of the disclosure. The system 100 includes a content delivery service 102, illustrated in this exemplary embodiment as being implemented in a server—for example one or more dedicated server devices, or a cloud based server.

By way of example, the cloud server of the content delivery service 102 may have processing facilities represented by processor functionality 104, memory functionality 106, and other components typically present in such computing environments. In the exemplary embodiment illustrated the memory 106 stores information accessible by processor 104, the information including instructions 108 that may be executed by the processor 104 and data 110 that may be retrieved, manipulated or stored by the processor 104. The memory 106 may be of any suitable means known in the art, capable of storing information in a manner accessible by the processor, including a computer-readable medium, or other medium that stores data that may be read with the aid of an electronic device. The processor 104 may be any suitable device known to a person skilled in the art. Although the processor 104 and memory 106 are illustrated as being within a single unit, it should be appreciated that this is not intended to be limiting, and that the functionality of each as herein described may be performed by multiple processors and memories, that may or may not be remote from each other. The instructions 108 may include any set of instructions suitable for execution by the processor 104. For example, the instructions 108 may be stored as computer code on the computer-readable medium. The instructions may be stored in any suitable computer language or format. Data 110 may be retrieved, stored or modified by processor 104 in accordance with the instructions 108. The data 110 may also be formatted in any suitable computer readable format. Again, while the data is illustrated as being contained at a single location, it should be appreciated that this is not intended to be limiting—the data may be stored in multiple memories or locations. The data 110 stored on server may include databases 112.

The content delivery service 102 may communicate with external database services 114, content providers 116, and content processing services 118, via a network 120. As will be described further below, the external database services 114 may be used to store and access content, advertising material, and other data associated with the content delivery service 102. Content providers 116 may include, for example, a media file delivery service provider (such as a content delivery network, media streaming service provider, cloud data services provider, or other third-party media file delivery service provider)—whether pre-recorded content, or a transmission from a live event. It is also envisaged that the content delivery service 102 may also include a library of original or platform specific content, rather than receiving content from external sources. Content processing services 118 may include, for example, video processing and player management services—such as those offered by Brightcove, Inc.

The network 120 may comprise various configurations and protocols including the Internet, intranets, virtual private networks, wide area networks, local networks, private networks using communication protocols proprietary to one or more companies—whether wired or wireless, or a combination thereof. The content delivery service 102 may communicate with user devices via the network 116, for example an advertiser workstation 122, a consumer smartphone 124a, a consumer tablet computer 124b, or consumer smart television 124c to provide access to the functionality of the content delivery service 102.

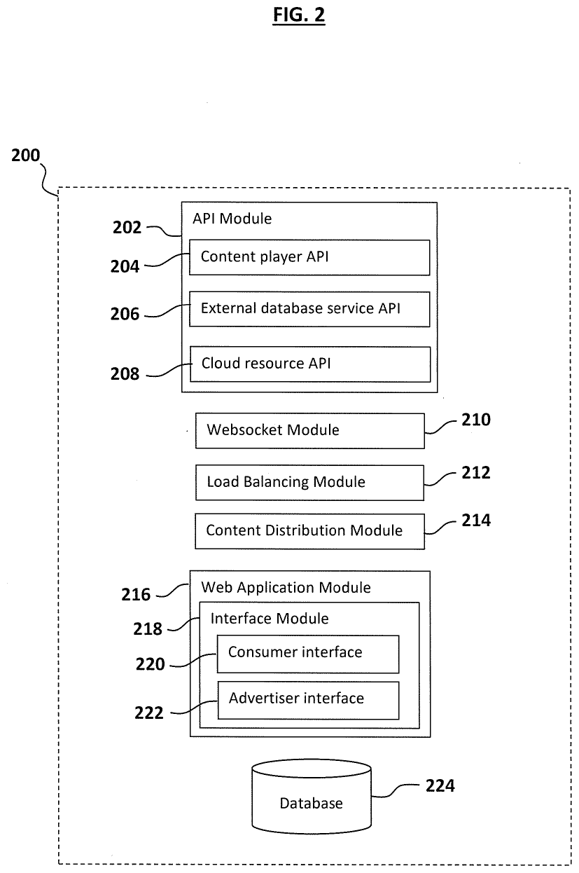

FIG. 2 illustrates an exemplary structure 200 of the content delivery service 102. The service 102 includes an application programming interface (API) module 202 configured to manage interfacing with the other services and devices within the system 100. A content player API 204 manages interfacing with content processing services 118 for provision of the content for delivery to the consumer. An external database service API 206 manages interfacing with external database services 114, while cloud resource API 208 manages interfacing with the cloud service provider to gain access to various functions and services as will be described with reference to the exemplary embodiments of FIG. 3-1 and FIG. 3-2.

A websocket module 210 is provided for establishing persistent client-server connections, with the objective of reducing undesirable characteristics such as delay and/or latency, which is envisaged as being of particular importance in the delivery of video content. A load balancing module 212 is provided for distributing traffic across multiple virtual server instances as required by current load on the system. A content distribution module 214 is provided for managing spatial distribution of content to end consumers.

The content delivery service 102 includes a web application module 216 for provision of a consumer facing web application through which applicable content and functions of the service are accessed. The web application module 216 may include an interface module 218 for delivery of user interfaces by which a user may access data and functionality of the service 102. For example, the interface module 218 may include a consumer interface engine 220 to deliver one or more interfaces through which a consumer may establish terms of delivery of the content, and receive that content. The interface module 218 may include an advertiser interface engine 222 to deliver one or more interfaces through which an advertiser may establish a campaign to be delivered with content, implement a campaign, and monitor progression of that campaign. It should be appreciated that the system may utilise other storage means in addition to the external database services 114, for example cloud instance storage 224.

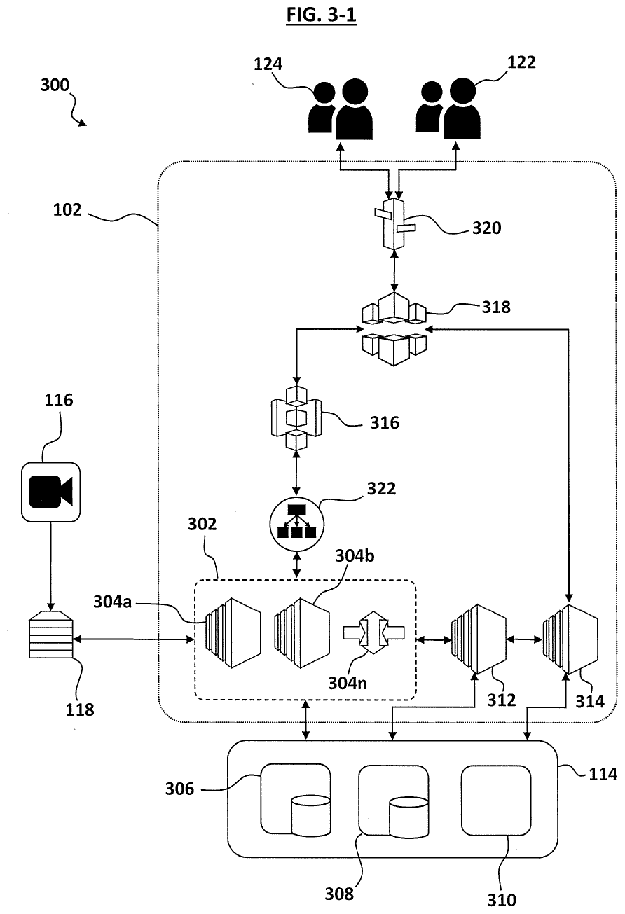

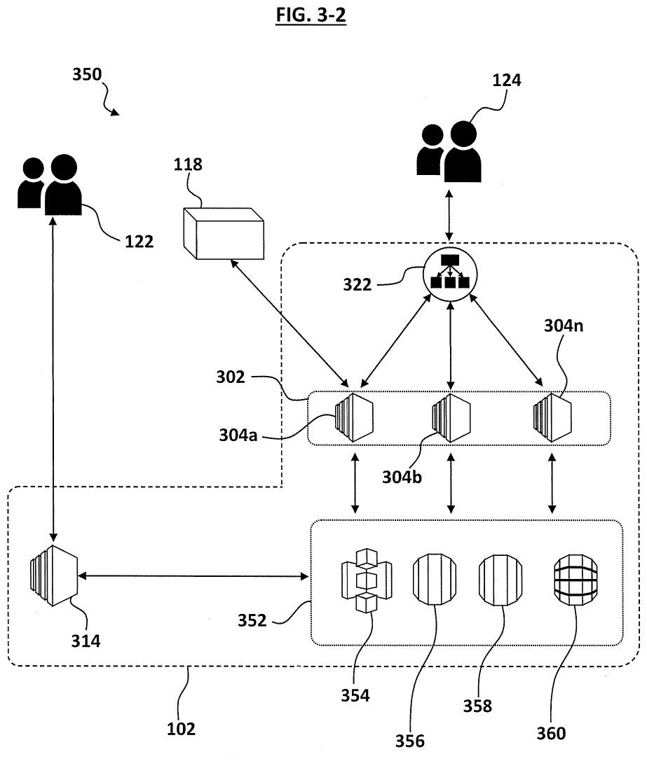

FIG. 3-1 illustrates an exemplary architecture 300 for the content delivery service 102, implemented within a cloud computing environment. Instance server group 302 provides cloud computing capacity, including instance servers 304a to 304n, with automated scaling functionality monitoring traffic through the instance servers 304a to 304n and adjusting capacity on demand. In this exemplary embodiment, the external database services 114 include a master MySQL database 306, a slave MySQL database 308, and a NoSQL database 310 (for example a MongoDB database). A websocket server 312 (for example using Node.js) is provided for establishing websockets.

An advertiser portal 314 provides an interface by which advertisers establish, implement, and monitor campaigns. A web application (for example using Vue.js) is hosted using a cloud object storage service 316 (for example, Amazon S3), providing an interface for consumers. A content distribution service 318 (for example, Amazon CloudFront), and Domain Name System (DNS) service 320 (for example, Amazon Route 53) facilitate traffic to and from the system, and advertisers 122 and consumers 124. A load balancer 322 is provided to distribute traffic across the instance servers 304a-n. In addition to provision of a video player for the consumer interface, and delivery of the content, the content processing service 118 manages authentication of advertising and content feeds, to reduce the risk of illegitimate and potentially illegal content feeds being delivered.

FIG. 3-2 illustrates another exemplary architecture 350 for the content delivery service 102, implemented within a cloud computing environment. In a similar manner to architecture 300, instance server group 302 provides cloud computing capacity, including instance servers 304a to 304n, with automated scaling functionality monitoring traffic through the instance servers 304a to 304n and adjusting capacity on demand.

In this exemplary embodiment, the external database services 114 are replaced by public cloud storage services 352, including a cloud object storage service 354 (for example, Amazon S3) storing images and advertising, a read only relational database 356 (for example a first Amazon RDS), a write only relational database 358 (for example a second Amazon RDS), and a NoSQL database 360 (for example, Amazon DynamoDB) for storing and retrieving logs.

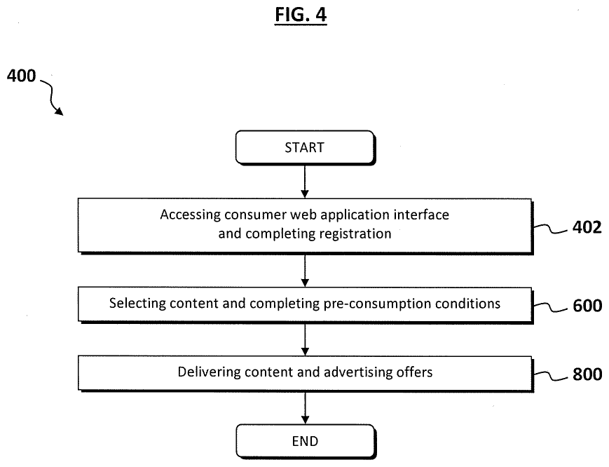

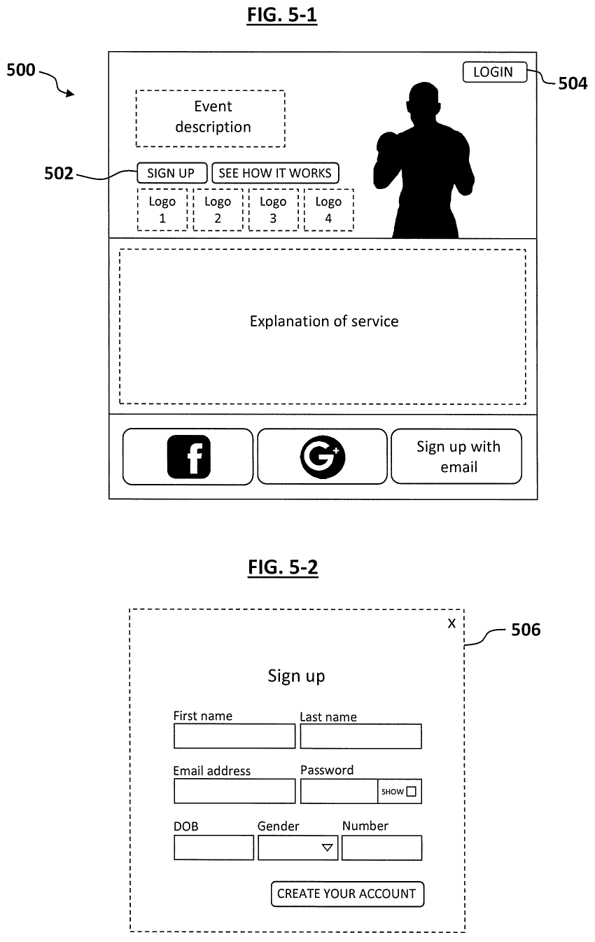

FIG. 4 illustrates a method 400 for delivery of content to a consumer. In step 402, a consumer accesses a consumer web application interface of the content delivery service 102, and completes a registration process for eligibility to access content. FIG. 5-1 shows an exemplary landing page 500 of the consumer web application, including a sign-up button 502—selection of which launches a registration form (shown in FIG. 5-2) for collection of consumer information. Additionally, the landing page 500 provides means for previously registered users to login—for example using login button 504.

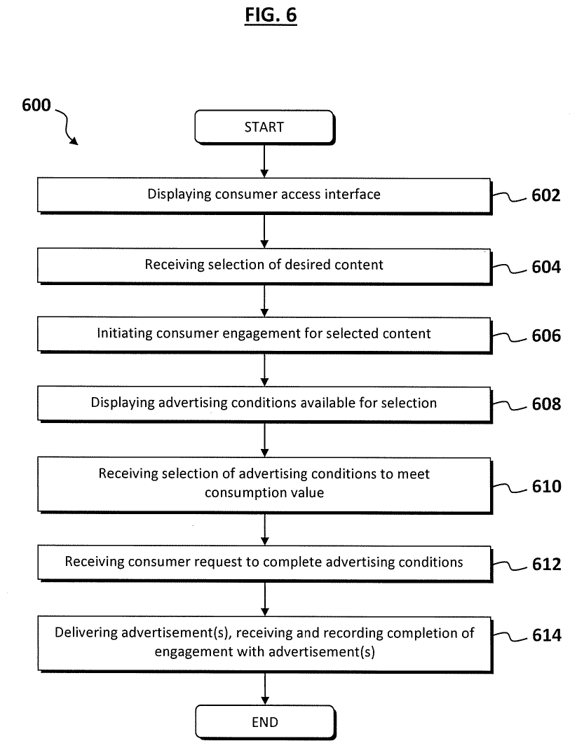

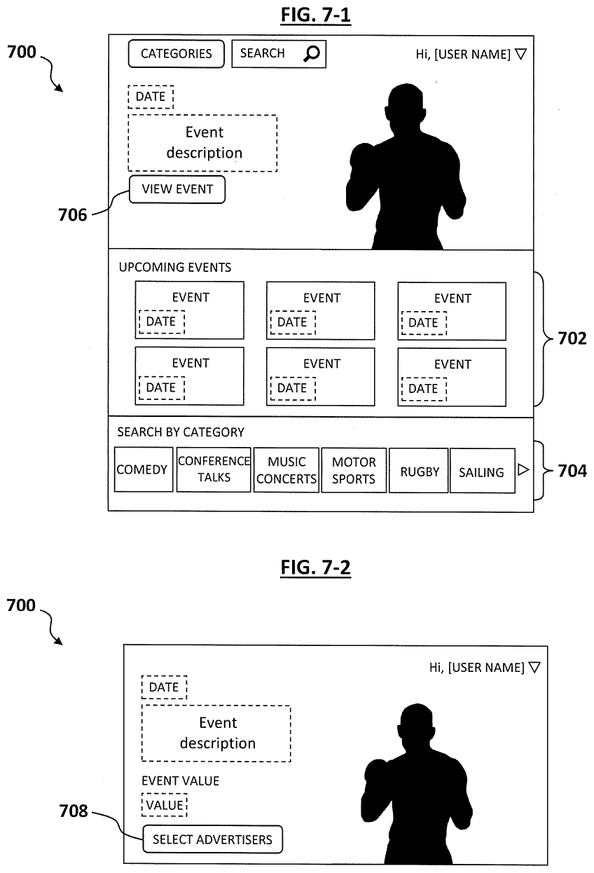

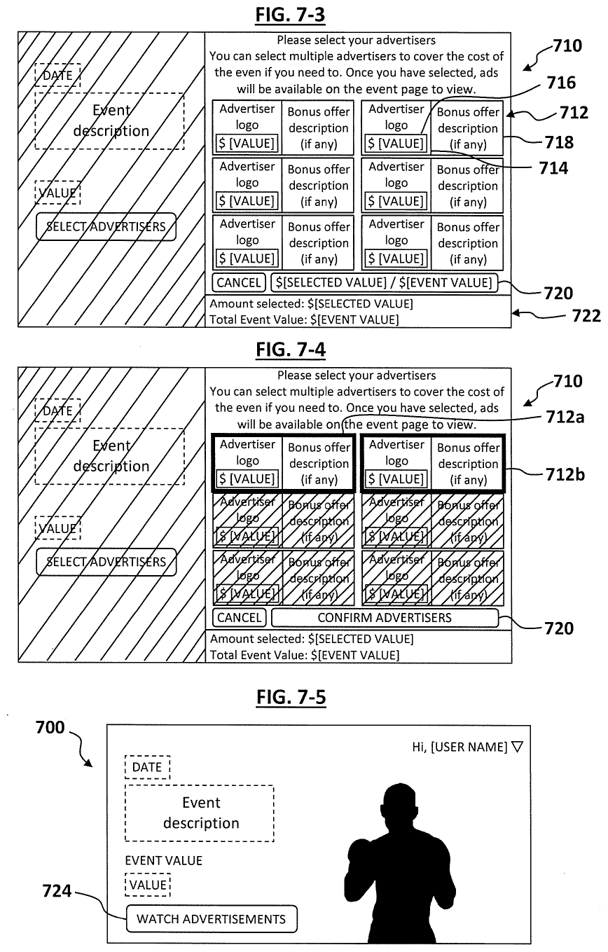

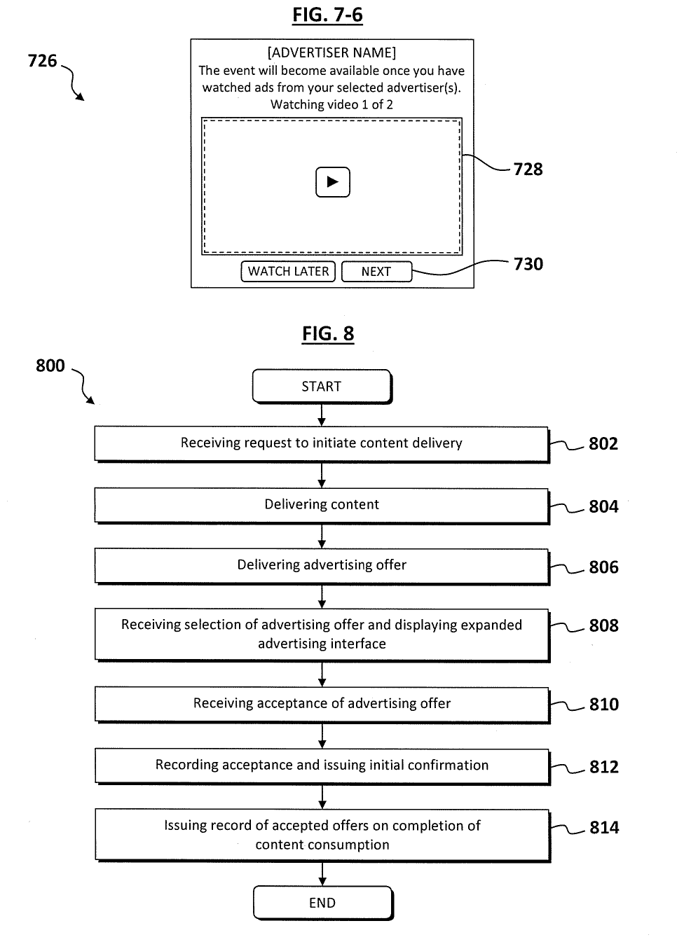

Referring to FIG. 4, in step 600 of the method 400, selection of content for consumption is received from the consumer, and pre-consumption conditions are satisfied. FIG. 6 illustrates an expanded process 600, where in step 602 a consumer access interface is displayed. FIG. 7-1 illustrates an exemplary consumer access interface 700, displaying a plurality of selectable event icons 702 for upcoming events. Consumers may search events—for example via categories 704, or text searching as known in the art. In exemplary embodiments, a promoted event may be displayed in a prominent position within consumer access interface 700, and an event selector button 706 button provided.

Referring to FIG. 6, in step 604 a selection of desired content is received—for example via event selector button 706 of FIG. 7-1—and additional detail of the event is displayed, for example: a description of the event, and a consumption value of the event (as shown in FIG. 7-2). In step 606 the consumer initiates engagement with advertising to subsidize the consumption value—for example by selection of advertiser selection button 708.

In step 608, a plurality of advertising conditions are displayed to the consumer for selection, each advertising condition have an associated value contributing towards meeting the consumption value for the event. For example, in FIG. 7-3 an advertising selection interface 710 is displayed, including a plurality of selectable advertising conditions 712. Each advertising condition 712 includes an advertiser identifier 714 (for example, a logo), a visual indication 716 of the associated value in terms of contribution toward the consumption value, and a description of an associated initial offer (for example, a discount or promotion). In this exemplary embodiment, an advertising confirmation button 720 is designated as non-selectable until the consumption value is met—with an indication 722 of total selected advertiser contributions against the consumption value displayed within the advertising selection interface 710.

In step 610 of FIG. 6, selections of first advertising condition 712a and second advertising condition 712b are received, and the advertising confirmation button 720 enabled on confirmation that the total selected value is equal to or greater than the consumption value of the content (as seen in FIG. 7-4).

Following selection of the advertising confirmation button 720, a watch advertisement button 724 is provided in the consumer access interface 700 (as seen in FIG. 7-5). In step 612, the consumer requests progression to completion of the selected advertising conditions by selection of the watch advertisement button 724. In step 614, advertisements are presented to the consumer for completion of advertising conditions prior to obtaining access to the event content. For example, an advertiser viewer 726 of FIG. 7-6 may be displayed, with a video player 728 playing advertisements associated with the conditions selected by the consumer. On completion of the advertisements, a view confirmation button 730 is enabled to allow the consumer to confirm their engagement with the advertisements, and that the advertisement conditions have been satisfied.

It is envisaged that this arrangement may avoid interruptive “push-through” advertising methods, because the consumer is using a “pull-through” method to select advertising in order to consume the content. That is, advertising is being used as a currency to buy content. Subsequently, negative emotive responses to intrusive and interruptive advertising are removed (i.e. shifting the consumer towards an engaged and positive buying emotion) in preparation for sale qualification and closure.

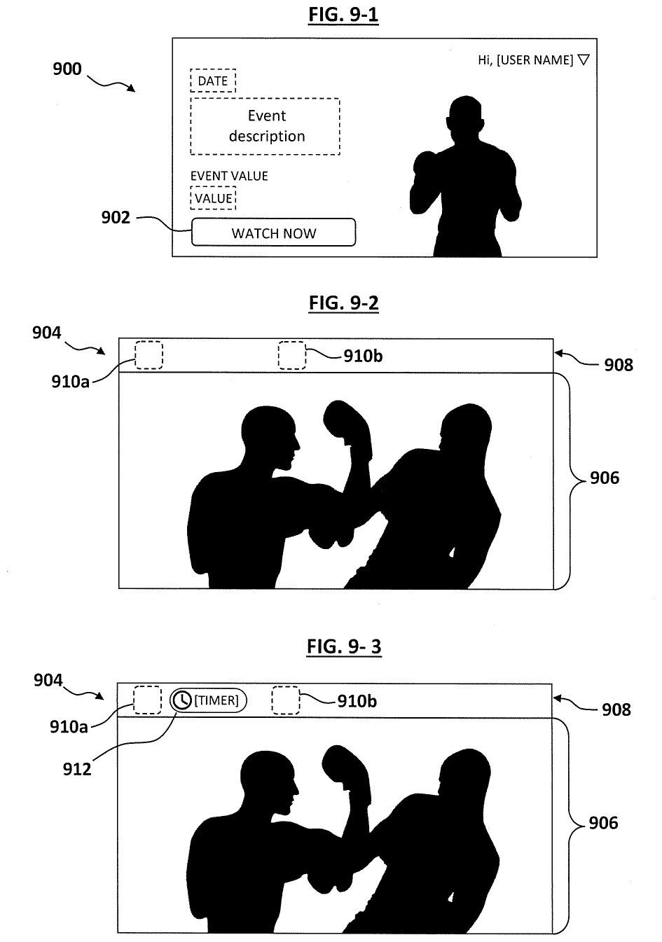

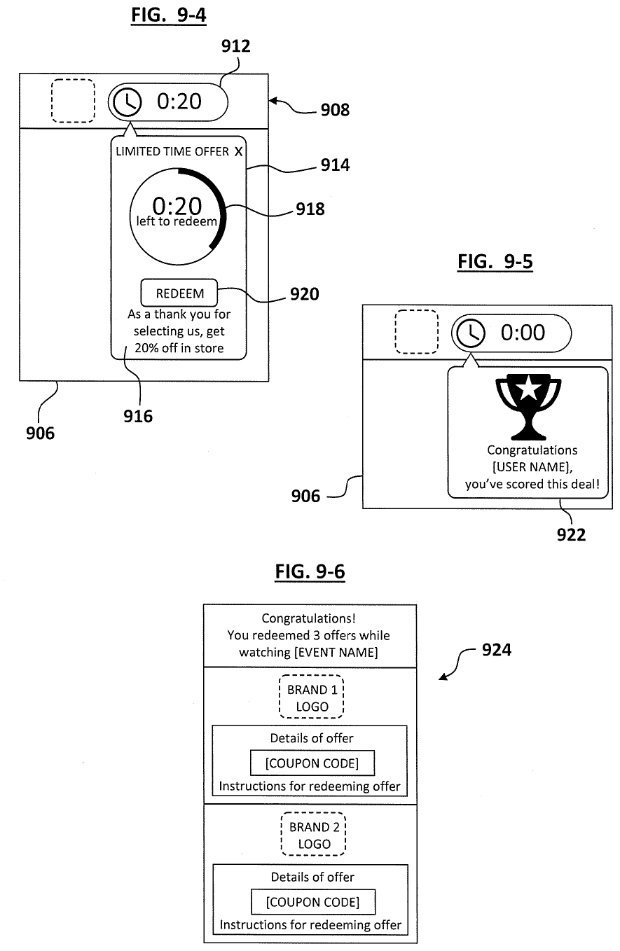

Referring to FIG. 4, following completion of step 600, step 800 is performed—delivering content, and advertising offers, to the consumer. FIG. 8 provides an expanded process 800, in which step 802 includes receiving a request to initiate content delivery. For example, FIG. 9-1 shows a consumer access interface 900 following completion of the advertising conditions—displaying a selectable access button 902 to initiate viewing of the content.

By providing a means for consumers to gain access to the content at what they deem to be an acceptable consumption cost, it is envisaged that the temptation for consumers to seek out illegal content, and infringe upon the creative, unique or original content of others may be reduced. This is envisaged as lowering legal recourse and prosecutions by content providers and creators, and keeping a healthier consumer-content provider market balance in place. It is further envisaged that the risk profile of content consumption may be reduced, particularly for consumers making purchase decisions with disposable income.

In step 804, the content is delivered to the consumer. For example, FIG. 9-2 illustrates a consumer content player 904, including a content viewing portion 906 (for example a video player).

In step 806, advertising offers are delivered to the consumer during delivery of the content. The consumer content player 904 includes a real-time advertising bar 908 in which advertiser icons (for example, first advertiser icon 910a and second advertiser icon 910b) are displayed. In exemplary embodiments, one or more of the advertising icons may be persistent throughout viewing of the content. A newly received offer associated with an advertiser icon may be indicated by visually emphasising the icon (for example, highlighting the icon, or adding a counter next to the icon). In exemplary embodiments, one or more of the advertising icons may only be presented on initiation of an advertising offer.

In an exemplary embodiment, an advertising offer may have a limited availability period. For example, in FIG. 9-3 a countdown timer 912 is displayed, indicating the remaining time available for the consumer to have the opportunity to accept the offer by selecting the timer and/or associated first advertiser icon 910a.

In step 808, selection of the adverting offer is received, and an expanded advertising interface is displayed. For example, referring to FIG. 9-4, selection of the countdown timer 912 displays an expanded advertising offer overlay 914, including a description of the offer, an enlarged countdown timer 918, and an offer acceptance button 920. In step 810, acceptance of the advertising offer is received, and in step 812 the acceptance is recorded against the consumer's account and an initial confirmation issued—for example confirmation message 922 (see FIG. 9-5). On completion of content consumption, a record of accepted offers is issued in step 814. An exemplary record 924 is shown in FIG. 9-6—including coupon codes for redemption of the offers.

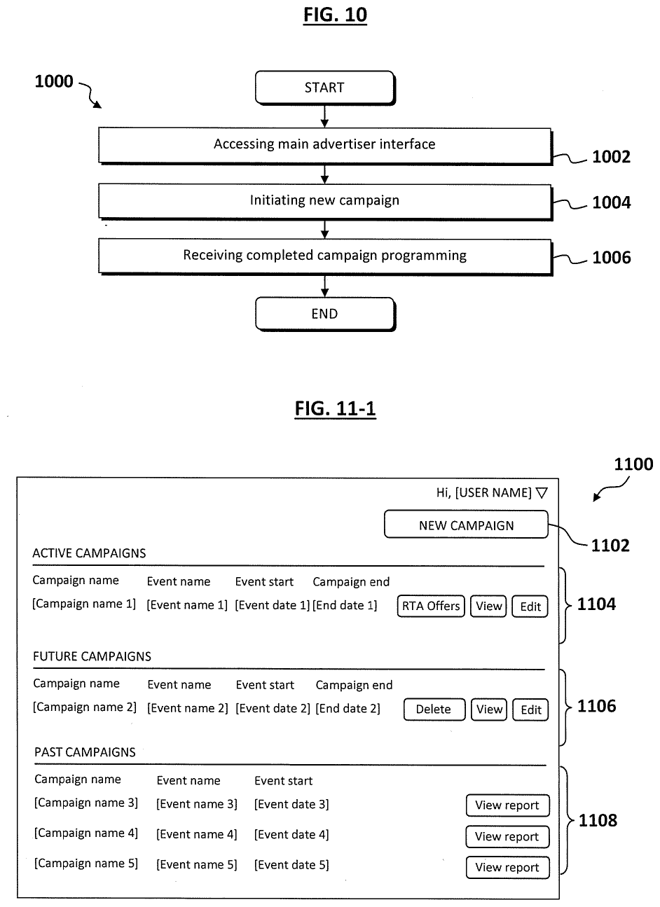

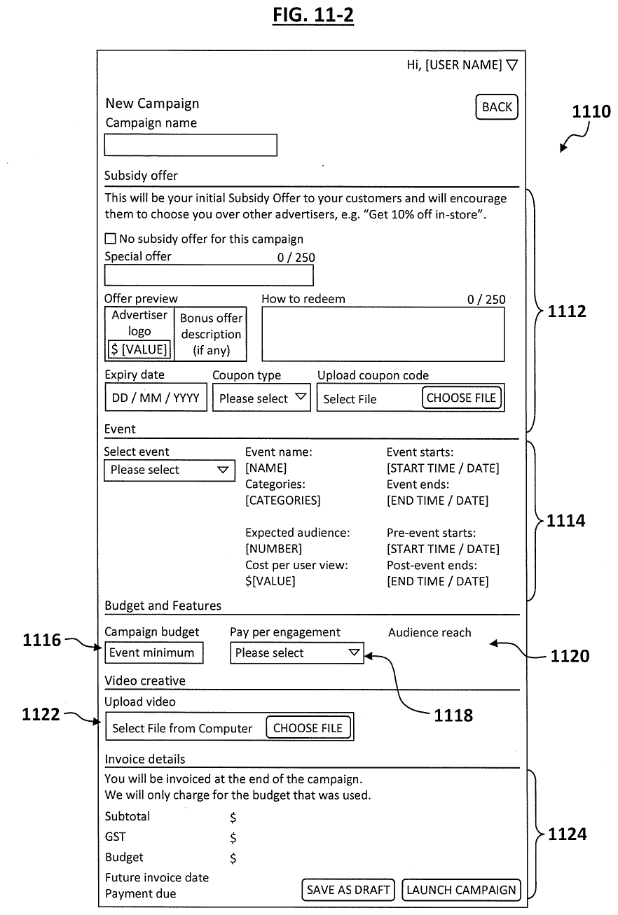

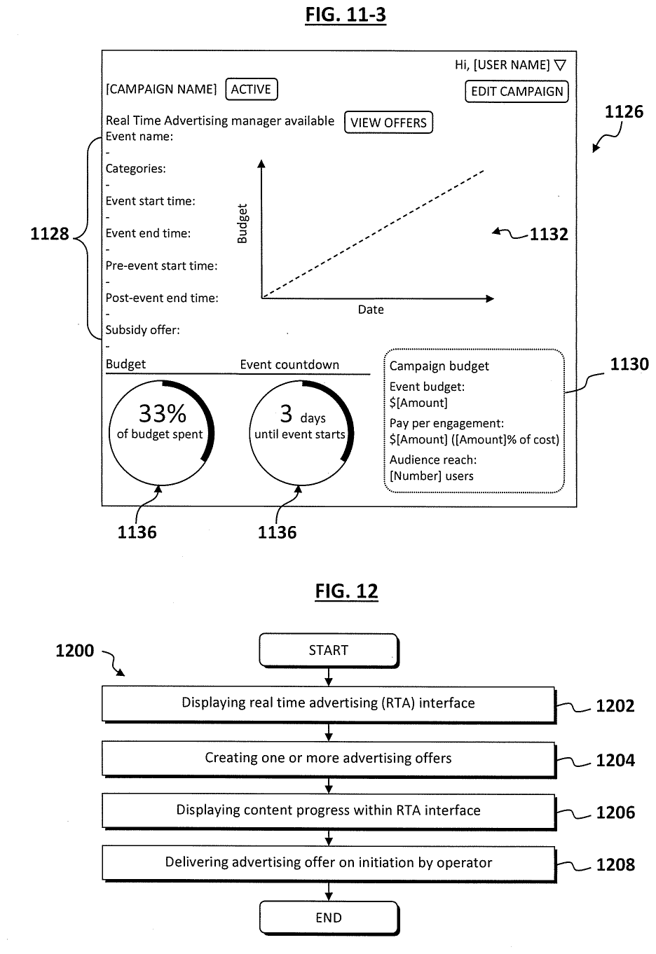

FIG. 10 illustrates a method 1000 for establishing an advertising campaign for content—more particularly content relating to an event. In step 1002, an advertiser accesses a main advertiser interface via the advertiser portal—for example main advertiser interface 1100 as shown in FIG. 11-1. The main advertiser interface 1100 includes a new campaign button 1102 for establishing an advertising campaign. The main advertiser interface 1100 further includes a first record of active campaigns 1104, a second record of future campaigns 1106, and a third record of past campaigns 1108. In step 1004 the advertiser initiates a new campaign—for example, by selection of new campaign button 1102.

FIG. 11-2 shows a new campaign template 1110 for completion by an advertiser, including an initial offer section in which the advertiser can populate details of the initial offering to be presented with an advertising condition to a consumer in step 614, and a content section 1114 in which content may be selected and associated information displayed. A budget entry field 1116 enables an advertiser to enter their total budget for a campaign, while a value per consumer may be selected using drop down menu 1118—with the associated audience reach calculated and displayed in audience reach display 1120. An advertising video uploader 1122 is provided for uploading videos to be presented to the consumer when satisfying an advertising condition, while an invoice section 1124 is automatically populated.

In step 1006 of the method 1000 of FIG. 10, the completed campaign programming is recorded against the advertiser's account, and displayed for selection in the main advertiser interface 1100. Campaigns may be selected for viewing of information associated with the campaign (for example, report 1126 of FIG. 11-3)—such as event details 1128, budgeting details 1130, a graphical representation 1132 of consumer selection of the advertiser's initial offer as an advertising condition for the event, a first infographic 1134 of budget spend to date, and a second infographic 1136 of time until event initiation.

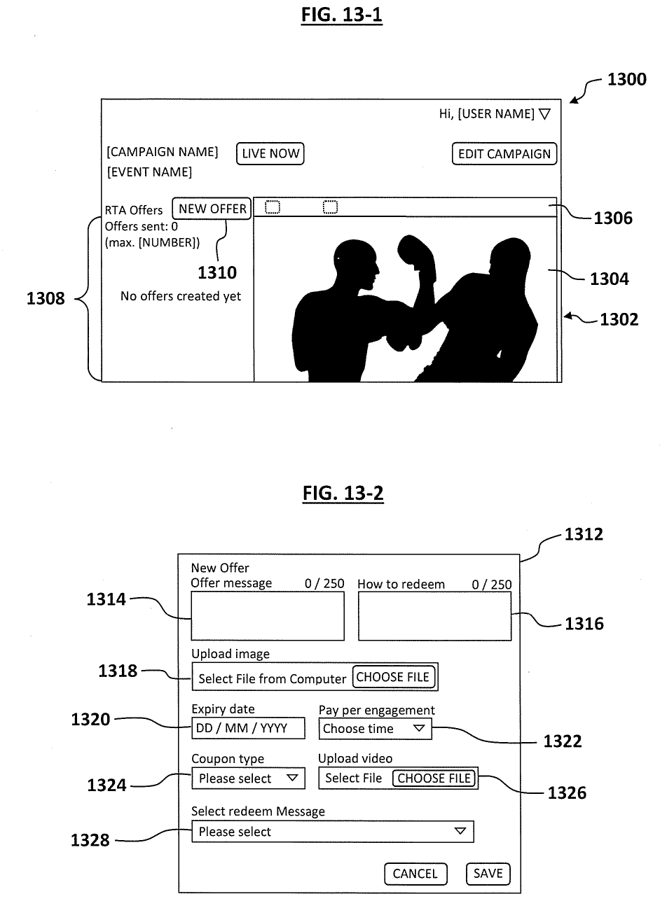

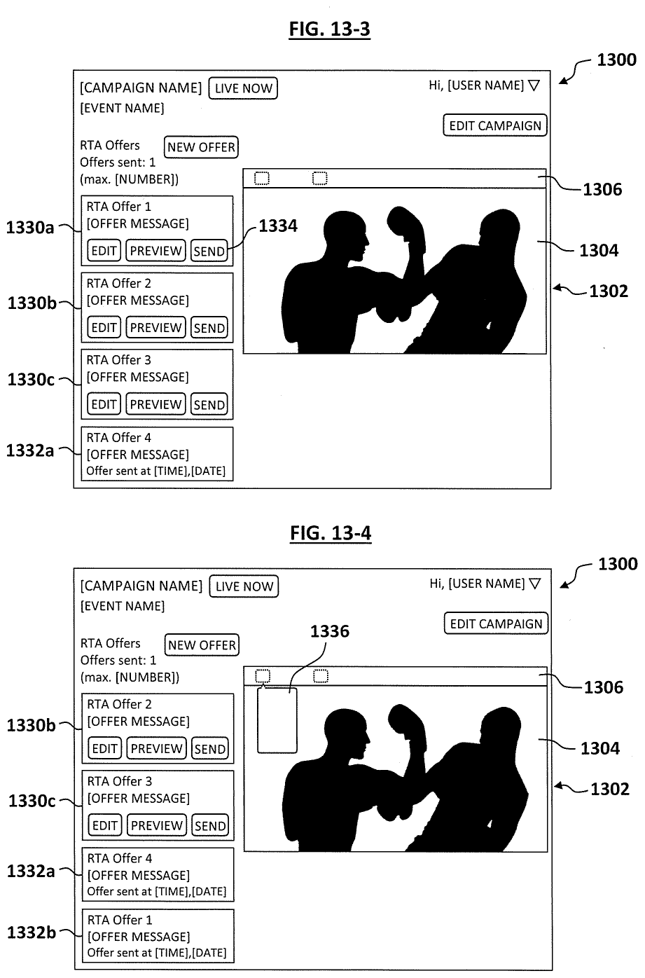

FIG. 12 illustrates a method 1200 for provision of real-time advertising during delivery of content. In step 1202, a real-time advertising (RTA) interface is displayed on selection of a campaign via the main advertiser interface. For completeness, it should be appreciated that the RTA interface and associated functionality may be implemented in conjunction with other forms of service delivery. Referring to FIG. 13-1, an RTA interface 1300 may include a content player 1302, including a content viewing portion 1304 and a real-time advertising bar 1306 in order that an advertiser may view content simultaneously with consumers in order to gauge opportunities for delivery of advertising offers. The RTA interface 1300 includes an offer section 1308 in which prepared advertiser offers are listed, and an advertiser offer button 1310 presented for generation of new offers.

In step 1204, advertising offers are created—for example, using offer template 1312 presented to the advertiser on selection of the offer button 1310. The offer template 1312 may include an offer message field 1314 for entry of a message to be presented to a consumer on initial selection of an offer, an explanation field 1316 for entry of a description of how to redeem the offer, an image uploader 1318, and expiry date selector 1320, a countdown timer selector 1322, a coupon type drop-down menu 1324, coupon code uploader 1326, and redeem message drop down menu 1328.

Referring to FIG. 13-3, un-sent advertising offers 1330a-c are displayed next to the content player 1302, along with a record of sent advertising offers, including first sent advertising offer 1332a. In step 1206, the content progress is displayed in the content player 1302, for monitoring of developments in the content to gauge opportunities to send the advertising offers 1330a-c. Send offer buttons 1334 are provided for each advertising offer 1330a-c—and in step 1208 the advertiser selects an associated send offer button 1334 for delivery of the advertising offer. In exemplary embodiment, an expanded advertising interface 1336 may be displayed of delivery of the offer (as shown in FIG. 13-4) although it should be appreciated that this may be initiated on selection of an associated icon in the real-time advertising bar 1306.

FIG. 4 illustrates a method 400 for delivery of content to a consumer. In step 402, a consumer accesses a consumer web application interface of the content delivery service 102, and completes a registration process for eligibility to access content. FIG. 5-1 shows an exemplary landing page 500 of the consumer web application, including a sign-up button 502—selection of which launches a registration form (shown in FIG. 5-2) for collection of consumer information. Additionally, the landing page 500 provides means for previously registered users to login—for example using login button 504.

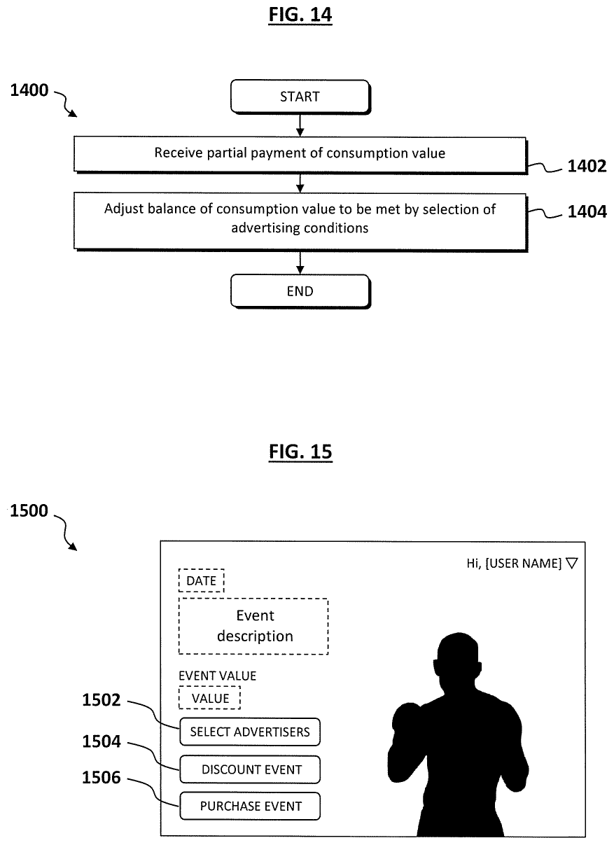

In an exemplary embodiment the method 400 may be modified to allow a consumer to pay at least part of the consumption value—more particularly prior to display and selection of advertising conditions in step 608 and step 610 of process 600. FIG. 14 illustrates a process 1400 to be performed between step 604 and step 606 of process 600. Referring to FIG. 15, another exemplary consumer access interface 1500 is displayed, in which the consumer is provided with the options to: initiate engagement with advertising to subsidize the consumption value by selection of advertiser selection button 1502, provide a partial payment of the consumption cost by selection of partial payment button 1504, or purchase the event outright through payment of the full consumption cost by purchase button 1506.

Following selection of the partial payment button 1504 or the purchase button 1506, a payment interface is displayed (for example, a credit card payment portal, or internet banking portal). Purchase effectively progresses the consumer through to completion of step 614 of process 600—i.e. ready for step 800 of method 400. On receipt of partial payment of the consumption value in step 1402 of method 1400, the remaining balance of the consumption value is determined and set for the user in step 1404. Subsequently, on selection of the advertiser selection button 1502 to initiate process 600 from step 606, the consumer is only required to select advertising conditions to meet the balance of the consumption value. This allows the consumer to self-determine the relative value they place on the event, against the need to engage with advertising.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

Aspects of the present invention have been described by way of example only and it should be appreciated that modifications and additions may be made thereto without departing from the scope thereof as defined in the appended claims.

1. A method including the steps of:
presenting a service package to a consumer via a user device, wherein each service package has an associated service, and a consumption value for delivery of the service, wherein presenting the service package includes presenting a plurality of selectable advertising conditions to the consumer, each condition having an associated subsidy value;
receiving selection of one or more of the advertising conditions having a combined subsidy value equivalent to, or greater than, the consumption value; and
delivering the service associated with the service package on completion of the selected advertising conditions.

2. The method of claim 1, wherein the plurality of advertising conditions are displayed in a user interface provided on the user device.

3. The method of claim 2, wherein the plurality of advertising conditions are displayed in selectable tiles within the user interface.

4. The method of claim 1, wherein the method includes the steps of:
receiving a partial payment for delivery of the service; and
adjusting the consumption value required to be met through selection of one or more of the advertising conditions by a value of the partial payment.

5. The method of claim 1, wherein the method includes the steps of:
presenting an advertising offer to the consumer during the delivery of the service, and
receiving an indication of acceptance of the offer by the consumer, and recording acceptance of the offer against records associated with the consumer.

6. The method of claim 5, wherein the service is delivered to the consumer via a service delivery interface including a service portion in which the service is displayed, and an active advertising area, wherein the presenting of the advertising offer is performed in the active advertising area during the delivery of the service.

7. The method of claim 6, wherein the advertising offer is presented as an icon within the active advertising area, wherein selection of the icon displays an expanded advertising interface for interaction with the consumer.

8. The method of claim 7, wherein the expanded advertising interface is displayed over at least a portion of the service portion of the service delivery interface.

9. The method of claim 7, wherein the advertising offer is designated as being selectable by the consumer for a limited period of time.

10. The method of claim 9, wherein an indication of the remaining time available to select the advertising offer is provided in one or more of: the advertising offer icon, and the expanded advertising interface.

11. The method of claim 5, wherein the presenting of the advertising offer is initiated by an operator.

12. The method of claim 5, wherein timing of the presenting of the advertising offer is pre-determined.

13. The method of claim 12, wherein the presenting of the advertising offer is initiated on an event occurrence.

14. The method of claim 5, wherein the advertising offer is presented to a subset of a total consumer base for the service.

15. The method of claim 1, wherein the associated service is provision of multimedia content.

16. A system for delivery of a service to a consumer, the system comprising at least one processing means configured to:
deliver a service package to a user device for presentation to the consumer, wherein each service package has an associated service, and a consumption value for delivery of the service, wherein presenting the service package includes presenting a plurality of selectable advertising conditions to the consumer in a user interface displayed on the user device, each condition having an associated subsidy value;
receive selection of one or more of the advertising conditions having a combined subsidy value equivalent to, or greater than, the consumption value; and
deliver the service associated with the service package to the user device on completion of the selected advertising conditions.
